(19) United States
(12) Patent Application Publication
(10) Pub. No.: US 2026/0352520 A1
(43) Pub. Date: Nov. 5, 2026

(54) ADAPTIVE MATCHING MODULE AND COMMUNICATION STRUCTURE

(71) Applicant: SHANGHAI XINLONG SEMICONDUCTOR TECHNOLOGY CO., LTD., Shanghai (CN)

(72) Inventors: Bin LIU, Shanghai (CN); Ruiping LI, Shanghai (CN)

(73) Assignee: SHANGHAI XINLONG SEMICONDUCTOR TECHNOLOGY CO., LTD., Shanghai (CN)

(21) Appl. No.: 19/105,101

(22) PCT Filed: Nov. 14, 2023
(86) PCT No.: PCT/CN2023/131399

§ 371 Date: Feb. 20, 2025

(30) Foreign Application Priority Data
Jul. 7, 2023 (CN) 202310825609.1

(51) Int. Cl. H04L 25/02; H04L 12/40; H04L 25/49

(52) U.S. Cl. CPC H04L 25/0278; H04L 12/40169; H04L 25/4919; H04L 2012/4026

(57) ABSTRACT

The present invention provides an adaptive matching module and a communication structure. The adaptive matching module includes a state-switchable node, a delay unit, a switch unit and a waveform optimization unit. The state-switchable node switches its operating state according to a signal at the encoder input, and the delay unit restores the operating state of the state-switchable node after the elapse of a delay time. The switch unit connects the waveform optimization unit into the system only when there is a need to send a signal. When connected into the system, the waveform optimization unit reduces a transition period. With this arrangement, the waveform optimization unit reduces limitations of the transition period on the communication rate during the sending of a signal, and is disconnected when there is no need to send a signal. Thus, the waveform optimization unit does not affect electrical parameters of the entire system, overcoming the problem that it is conventionally impossible to further improve the communication rate, whether matching elements are added or not.

### TECHNICAL FIELD

The present invention relates to the field of integrated circuit (IC) technology, and particularly to an adaptive matching module and a communication structure.

### BACKGROUND

Commercial air conditioning and other industrial applications with demanding stability requirements due to long distances between devices, heavy interference and complex operating conditions commonly employ wired communication to ensure reliability. In addition, long-range communication is generally achieved at the cost of reduced communication rates. As more and more such applications emerge and increasing numbers of devices are used therein, increasingly stringent demands are placed on communication, giving rise to a need for communication schemes allowing more nodes to communicate at faster rates over longer distances. Conventional solutions could not meet these demands.

In order to enable efficient transmission of a signal over a communication bus without reflection, which may distort the signal or make it unable to propagate far enough, a matching resistor is usually added to the bus to provide impedance matching. The matching resistor is usually added to terminate the distal end of the bus. However, this may fail to work properly if the bus is too long, or too many devices are connected to the bus—desirable communication quality may be obtained only at devices close to the matching resistor but not at those far away from the matching resistor; and in this case, increasing the communication rate may make almost all the devices unable to communicate properly. In theory, this can be addressed by adding a matching resistor to a communication port of each device. However, this approach is only applicable when a small number of devices are connected to the bus. This is because, since the communication interface of each device is connected in parallel to the bus, the added matching resistors are connected in parallel, and since the matching resistance added to each device is several ohms, DC resistance of the bus may be too low to allow a signal to be transmitted without being diminished by the resistors. Therefore, there is an urgent need for a technique which allows a communication port of each device connected to a bus to be added with a matching resistor while not reducing the total DC impedance of the bus. In this way, an increased number of nodes can be added to the bus, and faster communication can be achieved over a longer distance.

For example, typical commercial air conditioners are multi-split systems including a single high-power outdoor unit and a certain number of indoor units. Most of these systems employ the HBS protocol to achieve reliable communication between the outdoor and indoor units. This protocol is advantageous in supporting non-polar communication over twisted pairs, and reliable multi-node communication can be achieved within a range of up to 500 m at a rate typically of 9.6 Kbps. In view of technological advancements and ever-increasing customer demands, it is necessary to further improve the current scheme by increasing 1) the number of communication nodes (i.e., more indoor and outdoor units can be connected to the bus in a mutually connectable and controllable manner), 2) the communication rate (a higher communication rate means higher communication efficiency, which results in time savings and enhanced user experience) and 3) the communication distance (a greater wired communication distance means a wider range of applicability).

Without any further improvements, increasing the number of communication nodes or the communication distance will increase parasitic loading of the bus and considerably weaken the advantage of terminating the distal end of the bus with a parallel matching resistor. Consequently, signal distortion may occur, which makes communication impossible. Generally, the communication rate is reduced as a trade-off, but this is contradictory to the need for a higher communication rate.

Therefore, conventionally, limited by the working principles of communication devices, it is impossible to further improve the communication rate, whether matching elements are added or not.

### SUMMARY

It is an objective of the present invention to provide an adaptive matching module and a communication structure, which overcome the above-described problem that it is conventionally impossible to further improve the communication rate, whether matching elements are added or not.

To this end, the present invention provides an adaptive matching module used with an encoder module in a system. The encoder module includes at least one encoder input and two encoder outputs. In response to a transition of a signal at the encoder input from a first level to a second level, a voltage difference between the two encoder outputs transitions from a preset voltage-difference value to 0 V over a transition period. A default value of the transition period has an impact on a communication frequency of the system.

The adaptive matching module including a matching input, a state-switchable node, a delay unit, a switch unit and a waveform optimization unit. The matching input is configured to receive the signal from the encoder input. The state-switchable node is switchable between at least a first operating state and a second operating state. When the state-switchable node is in the first operating state, in response to a transition of the signal at the encoder input from the first level to the second level, the state-switchable node switches to the second operating state. In response to a transition of the signal at the encoder input from the first level to the second level, the delay unit switches the state-switchable node from the second operating state back to the first operating state after the elapse of a delay time. The switch unit connects the waveform optimization unit into the system when the state-switchable node is in the second operating state and disconnects the waveform optimization unit from the system when the state-switchable node is in the first operating state. The waveform optimization unit, when connected into the system, reduces the transition period.

Optionally, the waveform optimization unit may be an impedance-matching resistor, which, when connected into the system, is connected between the two encoder outputs.

Optionally, the impedance-matching resistor may include a first resistor and a second resistor, wherein the switch unit includes a first triode and a second triode; bases of the first and second triodes are both connected to the state-switchable node; the first triode and the first resistor provide a path leading from a first one of the two encoder outputs to a second one thereof; the second triode and the second resistor provide a path leading from the second one of the two encoder outputs to the first one thereof; and when the first and second triodes are turned on, currents flow therethrough in opposite directions.

Optionally, the delay unit may include a delay capacitor, wherein in response to a transition of the signal at the encoder input from the first level to the second level, the delay capacitor experiences a change in its charge-discharge state, and after the elapse of the delay time, a voltage at one end of the delay capacitor reaches a value which triggers switching of the state-switchable node from the second operating state to the first operating state.

Optionally, the delay unit may include a constant-current subunit, wherein the delay capacitor is charged by a current output from the constant-current subunit.

Optionally, the delay unit may further include a discharge subunit, wherein when the signal at the encoder input is at the first level, the discharge subunit operates to continually discharge the delay capacitor, and when signal at the encoder input is at the second level, the discharge subunit is out of operation, and the delay capacitor receives charge from the constant-current subunit to gradually increase its voltage.

Optionally, the delay capacitor may be connected between the encoder input and the state-switchable node, wherein the end of the delay capacitor connected to the encoder input is configured as the matching input.

To the above end, the present invention also provides a communication structure including an encoder module and the adaptive matching module as defined above. The communication structure is used in a system. The encoder module includes at least one encoder input and two encoder outputs. In response to a transition of a signal at the encoder input from a first level to a second level, a voltage difference between the two encoder outputs transitions from a preset voltage-difference value to 0 V over a transition period, and a default value of the transition period has an impact on a communication frequency of the system. The first level may be one of a high level and a low level, and the second level may be the other of the high and low levels.

Optionally, the communication structure may be provided as a chip, wherein the encoder module and the adaptive matching module each form part of the chip. Alternatively, the encoder module may be a chip, wherein the adaptive matching module is mounted external to the chip as a separate component.

Optionally, the communication structure may be provided as a chip, wherein the delay unit includes a delay capacitor; in response to a transition of the signal at the encoder input from the first level to the second level, the delay capacitor experiences a change in its charge-discharge state, and after the elapse of a delay time, a voltage at one end of the delay capacitor reaches a value which triggers switching of the state-switchable node from the second operating state back to the first operating state; and the delay unit includes a constant-current subunit, and the delay capacitor is charged by a current output from the constant-current subunit.

The communication structure may include a delay adjustment port, which, when connected to different resistors, causes corresponding changes in the current from the constant-current subunit, thereby changing the delay time.

Compared with the prior art, in the adaptive matching module and the communication structure of the present invention, the adaptive matching module includes a matching input, a state-switchable node, a delay unit, a switch unit and a waveform optimization unit. The matching input is configured to receive a signal from the encoder input. The state-switchable node switches its operating state according to the signal from the encoder input, and the delay unit restores the operating state of the state-switchable node after the elapse of a delay time. The switch unit connects the waveform optimization unit into the system only when there is a need to send a signal, and keeps disconnected otherwise. When connected into the system, the waveform optimization unit reduces a transition period. With this arrangement, the waveform optimization unit reduces limitations of the transition period on the communication rate during the sending of a signal, and is disconnected when there is no need to send a signal. Thus, the waveform optimization unit does not affect electrical parameters of the entire system, overcoming the problem that it is conventionally impossible to further improve the communication rate, whether matching elements are added or not.

### BRIEF DESCRIPTION OF THE DRAWINGS

Those of ordinary skill in the art will understand that the following drawings are presented to enable a better understanding of the present invention and not intended to limit the scope thereof in any sense, in which:

FIG. 1 shows a schematic circuit diagram of an adaptive matching module according to an embodiment of the present invention;

FIG. 2 schematically illustrates waveforms of critical signals in a conventional system in ideal and practical scenarios;

FIG. 3 illustrates waveforms of the critical signals in the system with intervention of an adaptive matching module according to an embodiment of the present invention;

FIG. 4 shows a schematic circuit diagram of an adaptive matching module according to another embodiment of the present invention;

FIG. 5 is a schematic diagram showing the structure of a communication structure according to an embodiment of the present invention;

FIG. 6 is a schematic diagram showing the structure of a communication structure according to another embodiment of the present invention and a multi-split system;

FIG. 7 shows simulated waveforms in a conventional system at a communication rate of 100 Kbps; and

FIG. 8 shows simulated waveforms in a system incorporating an adaptive matching module according to an embodiment of the present invention at a communication rate of 100 Kbps.

In these figures,

1 denotes an adaptive matching module; 2, an encoder module; 3, a communication structure; 4, a communication bus; 11, a matching input; 12, a state-switchable node; 13, a delay unit; 14, a switch unit; 15, a waveform optimization unit; 21, an encoder input; and 22, an encoder output.

### DETAILED DESCRIPTION

Objectives, advantages and features of the present invention will become more apparent upon reading the following more detailed description with reference to the accompanying drawings, which illustrate particular embodiments thereof. Note that the figures are provided in a very simplified form not necessarily drawn to exact scale for the only purpose of helping to explain the disclosed embodiments in a more convenient and clearer way. In addition, the illustrated structures are usually part of their real-world counterparts. In particular, as the figures tend to have distinct emphases, they are sometimes drawn to different scales.

As used herein, the singular forms “a”, “an” and “the” include plural referents. The term “or” is generally employed in the sense of “and/or”, “several” of “at least one” and “at least two” of “two or more”. In addition, the terms “first”, “second” and “third” are intended only for illustration and are not to be construed as denoting or implying relative importance, or as implicitly indicating the number of the referenced items. Accordingly, defining an item with “first”, “second” or “third” is an explicit or implicit indication of the presence of one or at least two such items. The terms “one end” and “the other end”, as well as “proximal end” and “distal end”, are used to generally refer to opposing ends including the opposing endpoints, rather than only to the endpoints. As used herein, the terms “mounting”, “coupling”, “connecting” and any variants thereof should be interpreted in a broad sense. For instance, a connection may be a permanent, detachable or integral connection, or a mechanical or electrical connection, or a direct or indirect connection with one or more intervening media, or an internal communication or interaction between two elements. When an element is referred herein to as being “disposed on” another element, this is generally intended to only mean that there is a connection, coupling, engagement or transmission between the two elements, which may be either direct or indirect with one or more intervening elements, and should not be interpreted as indicating or implying a particular spatial position relationship between the two elements, i.e., the element may be located inside, outside, above, under, beside, or at any other location relative to the other element, unless the context clearly dictates otherwise. Those of ordinary skill in the art can understand the specific meanings of the above-mentioned terms herein, depending on their context.

In principle, the present invention seeks to provide an adaptive matching module and a communication structure, which overcome the above-described problem that it is conventionally impossible to further improve the communication rate, whether matching elements are added or not.

Although the embodiments disclosed herein are described in the context of the HBS protocol, it will be understood that these embodiments can function in the same way when used with other similar communication protocols.

The present invention will be described below with reference to the accompanying drawings.

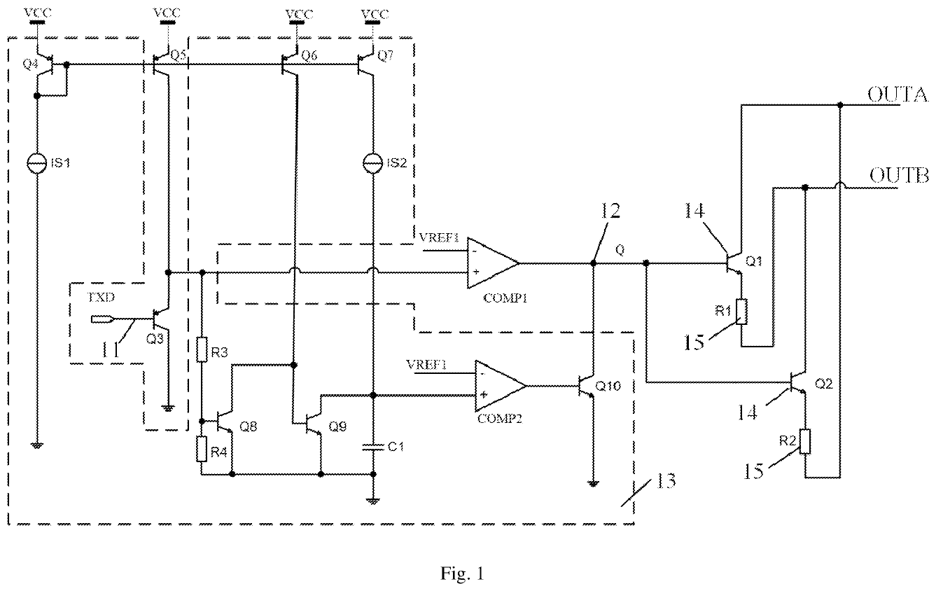

Referring to FIG. 1, in embodiments of the present invention, there is provided an adaptive matching module 1 for use with an encoder module 2 (not shown in FIG. 1, but in some of the other drawings) in a system. The encoder module may be implemented as a circuit, a chip, or a module in a chip.

The adaptive matching module 1 can be used in the development of a new communication chip capable of communication at a higher rate. Alternatively, it may be connected to a conventional mass-produced chip as an external module to increase the chip's communication rate. In this way, various needs of different customers can be satisfied.

The encoder module 2 includes at least one encoder input 21 and two encoder outputs 22. Operating logic of the encoder module is as described below. When a signal TXD at the encoder input 21 is kept at a first level (e.g., low), the difference between voltages at the two encoder outputs 22 is a preset value (e.g., the absolute value of which is 5 V) with a tolerable error. When the signal TXD at the encoder input is maintained at a second level (e.g., high), the difference between the voltages at the two encoder outputs 22 is 0 V with a tolerable error. In response to a transition of the signal TXD at the encoder input 21 from the first level to the second level, the voltages at the two encoder outputs 22 will transition, and the transitioning will be completed within a period of time. A default value of this transition period has an impact on a communication frequency of the system. For example, assuming that each communication period lasts for 0.2 ms and the default value of the transition period is 0.005 ms, a signal being communicated will remain uncertain over 2.5% of the 0.2-ms duration. Thus, in this case, the transition period can be considered as having an insignificant impact on the communication. If each communication period is reduced to 0.02 ms, then the signal will be uncertain over 25% of this duration. Additionally, assuming that the signal assumes the values ‘0’ and ‘1’ for equal periods of time, it will be uncertain over 50% of the duration in which it takes the value ‘1’. In this case, the transition period will greatly influence the communication, or may even make the signal unrecognizable. With the fact that the embodiments disclosed herein would not be implementable if an output signal of the encoder module 2 is free of influence from any external circuit in mind, the term “default value” should be interpreted as referring to a value of the delay time when the signal of the encoder module 2 is not subject to the influence from any external circuit, or to a value of the delay time in an open-circuit condition of the two encoder outputs 22.

The first level may be one of a high level and a low level, and the second level may be the other of the high and low levels. The following description is set forth in the context of the first level being low and the second level being high.

The adaptive matching module 1 includes a matching input 11, a state-switchable node 12 (also labeled as “Q”), a delay unit 13, a switch unit 14 and a waveform optimization unit 15. The matching input 11 is configured to receive the signal TXD from the encoder input 21. The state-switchable node 12 is switchable between at least a first operating state (which corresponds to a low level in this example) and a second operating state (which corresponds to a high level in this example). In the first operating state, the state-switchable node switches to the second operating state in response to a transition of the signal TXD at the encoder input from the first level to the second level. Moreover, in response to a transition of the signal TXD at the encoder input from the first level to the second level, the delay unit 13 switches the state-switchable node 12 from the second operating state back to the first operating state after the elapse of a delay time. The switch unit 14 connects the waveform optimization unit 15 into the system in the second operating state of the state-switchable node. The switch unit 14 disconnects the waveform optimization unit 15 from the system in the first operating state of the state-switchable node 12. When connected into the system, the waveform optimization unit 15 reduces the aforementioned transition period.

The first and second operating states may be implemented in various forms, which may be selected, as required, in practical applications. The high and low levels represent one possible implementation, and alternative implementations are possible. For example, the first operating state may be an ON state, and the second operating state may be an OFF state. As another example, the first operating state may correspond to an oscillating waveform, and the second operating state to a straight waveform. Many other examples are also possible. In particular, selection may be made based upon the properties of the elements and overall performance of the circuit.

The location where the waveform optimization unit 15 is connected to the system may be arbitrarily chosen, and the connection may be accomplished as shown in FIG. 1, or otherwise.

The waveform optimization unit 15 acts to reduce the transition period, and this may also be accomplished in various ways. For example, the waveform optimization unit 15 may be implemented as impedance-matching resistors R1 and R2, and may be connected into the system in such a manner that the impedance-matching resistors R1 and R2 are connected between the two encoder outputs 22. A first one of the two encoder outputs is denoted as OUTA, and a second one of them as OUTB. Here, the terms “first” and “second” are used only to distinguish the encoder outputs from each other, and are not intended to indicate any logical relationship between them. However, other waveform optimization approaches are also contemplated.

For ease of illustration, triodes shown in FIG. 1 are respectively referred to hereinafter as a first triode Q1, a second triode Q2, a third triode Q3, a fourth triode Q4, a fifth triode Q5, a sixth triode Q6, a seventh triode Q7, an eighth triode Q8, a ninth triode Q9 and a tenth triode Q10.

Operating logic of the state-switchable node 12 is as described below. When TXD is at the low level, a voltage Vbe is present at a collector of the third triode Q3 and a non-inverting input of a first comparator COMP1, and a voltage VREF1 is present at an inverting input of the first comparator COMP1. VREF1 may be set to such a proper value that VREF1>Vbe. As a result, a low level is present at an output of the first comparator COMP1, and the node is in the first operating state. When the TXD transitions from the low level to the high level, the voltage at the collector of the third triode Q3 increases to the amplitude of the signal TXD plus Vbe. The amplitude of the signal TXD is typically 3.3 V or 5.0 V, higher than VREF1. As a result, a low level is present at the output of the first comparator COMP1, and the node is in the second operating state. Operating logic of the delay unit 13 will be described in the following. VREF1 may be generated by a module, which may be configured as commonly known in the art. Further description in this regard is believed to be unnecessary and therefore omitted herein.

As shown in FIG. 1, the waveform optimization unit 15 (the impedance-matching resistors) includes a first resistor R1 and a second resistor R2, and the switch unit 14 includes a first triode Q1 and a second triode Q2. Bases of the first triode Q1 and the second triode Q2 are both connected to the state-switchable node 12. The first triode Q1 and the first resistor R1 provide a path leading from the first encoder output OUTA to the second encoder output OUTB. The second triode Q2 and the second resistor R2 provide a path leading from the second encoder output OUTB to the first encoder output OUTA. When the first triode Q1 and the second triode Q2 are turned on, currents flow therethrough in opposite directions.

It will be understood that, in alternative embodiments, one or more of the elements may be adapted, or one or more new elements may be added, so that the first triode Q1 and the second triode Q2 are PNP or NPN devices, in which R1 is connected to a current input or output terminal of Q1, and R2 is connected to a current input or output terminal of Q2. The foregoing description of Q1, Q2, R1 and R2 applies to all such modifications.

In this embodiment, as the switch is constructed with the triodes, it is necessary to establish both the forward and reverse paths. If there is any ideal switch element, which can conduct current in both directions, the switch unit 14 may be made up simply of the switch element, and accordingly, a single impedance-matching resistor may be used. Of course, the ideal switch element should provide comparable response to the triodes. Otherwise, the system may not be able to behave as designed due to slow operation of the switch element.

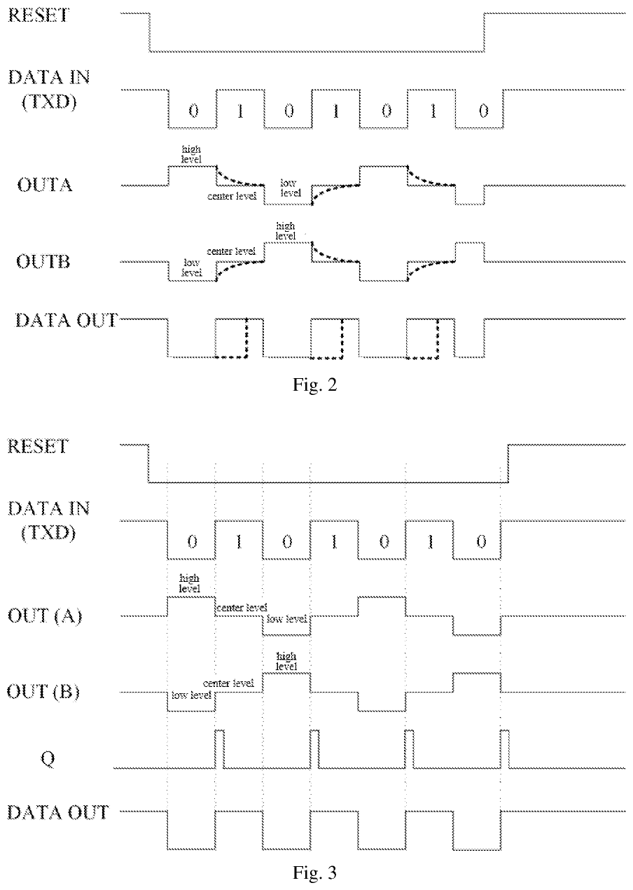

Reference is now made to FIGS. 2 and 3, which shows benefits provided by operation of the impedance-matching resistors. As shown in FIG. 2, the system starts operating when a signal RESET is at a low level. The location and operation of the signal RESET are not described in further detail herein for the sake of brevity. In FIG. 2, the solid lines represent an ideal scenario. When TXD is at the low level, a voltage difference between OUTA and OUTB is 5 V, and OUTA and OUTB alternately change their levels. When TXD is at the high level, both OUTA and OUTB transition to a center level, which is approximately 2.5 V. DATA OUT represents a decoded signal, or an intended output signal of the system. In the ideal scenario, DATA OUT is exactly in phase with TXD. The dotted lines represent a practical scenario. Any non-dotted segment can be considered as coinciding with the ideal scenario, or not coinciding with the ideal scenario but being irrelevant to the present application. As can be seen from the dotted lines, OUTA and OUTB transition to the center level slowly, but not instantaneously. Accordingly, after receiving the signals OUTA and OUTB, an external decode module will decode them into a signal as shown by the bottommost dotted line. This signal is problematic in that it has a very narrow high-level pulse width, which affects its communication quality, or may make it impossible to be communicated.

Referring to FIG. 3, the intervention of the impedance-matching resistors interconnects OUTA and OUTB for short periods of time, allowing their levels to interfere with each other and thereby immediately converge to the center level. In this way, the system can behave as designed. A voltage at the state-switchable node 12 (or “Q”) transitions high at the time when TXD transitions from ‘0’ to ‘1’ and then pulled back to a low level by the delay unit 13.

The delay unit 13 is designed to prevent R1 and R2 from remaining connected to the bus. According to the HBS protocol, among devices connected to a bus, only a single one of them is allowed to send a signal at any time. Accordingly, successful communication can be ensured while preventing low impedance of the bus simply by keeping the impedance-matching resistors disconnected from the bus unless a signal needs to be sent.

Referring to FIG. 1, the delay unit 13 includes a delay capacitor C1. In response to a transition of the signal TXD at the encoder input from the first level to the second level, the delay capacitor C1 experiences a change in its charge-discharge state. Moreover, after the elapse of the delay time, a voltage at one end of the delay capacitor C1 reaches a value, which triggers switching of the state-switchable node from the second operating state to the first operating state.

Specifically, the delay unit includes a constant-current subunit and is charged by a current output from the constant-current subunit. In FIG. 1, the constant-current subunit is made up of the fourth triode Q4, the seventh triode Q7, a first constant-current element IS1 and a second constant-current element IS2. IS1 provides a current mirror module with a reference current source, and IS2 serves for constant-current charging of C1.

The delay unit 13 further includes a discharge subunit. When the signal at the encoder input is at the first level, the discharge subunit operates to continually discharge the delay capacitor. When the signal at the encoder input is at the second level, the discharge subunit is out of operation, and the delay capacitor receives charge from the constant-current subunit and thereby gradually increases its voltage. In FIG. 1, the discharge subunit is made up of a third resistor R3, a fourth resistor R4, the sixth triode Q6, the eighth triode Q8 and the ninth triode Q9.

When TXD is low, the voltage at the collector of Q3 is approximately equal to Vbe with respect to the ground. Consequently, Q8 is turned off and Q9 on, discharging C1 until it is depleted. When TXD is high, the voltage at the collector of Q3 is equal to the amplitude of the signal TXD plus Vbe. Consequently, Q8 is turned on and Q9 off. Therefore, C1 is not discharged, but is continually charged by IS2. Upon a voltage at an upper end of C1 rising above VREF1 at a certain time, a voltage at a second comparator COMP2 is pulled high, turning on Q10. As a result, the voltage that turns on the state-switchable node 12 drops to 0. In other words, this is triggered by the voltage at the upper end of C1 rising above VREF1.

Further, in order to enable normal operation of the adaptive matching module 1, emitters of Q4, Q5, Q6 and Q7 are connected to a power supply VCC.

Since the MCU sets the signal TXD high when no signal is sent therefrom, this timer module can also function to prevent undesirable low impedance of the bus, which may otherwise occur when TXD is always high and therefore R1 and R2 remain connected to the bus.

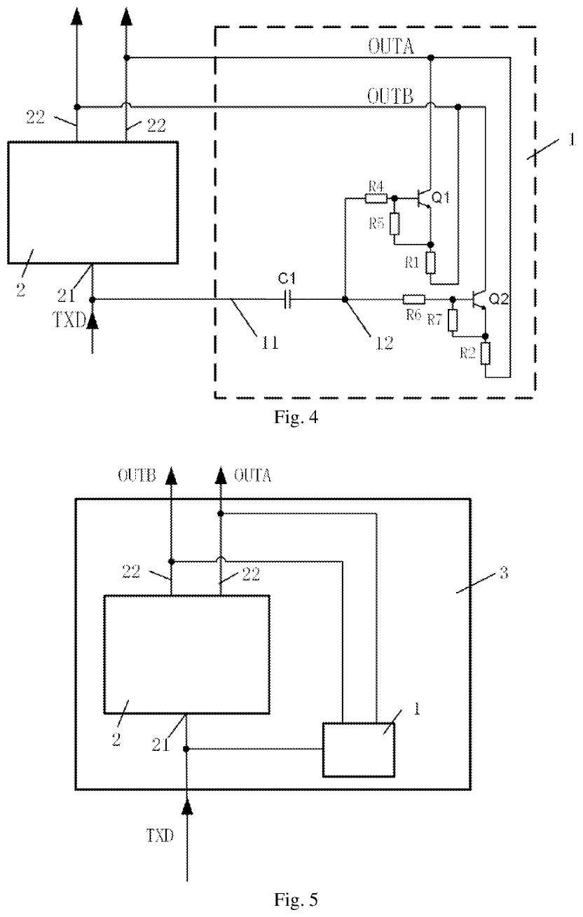

It will be understood that the delay unit 13 is not limited to the particular implementation shown in FIG. 1. FIG. 4 shows an alternative implementation, in which the delay capacitor C1 is connected between the encoder input 21 and the state-switchable node 12, and the end of the delay capacitor C1 connected to the encoder input 21 is configured as the matching input 11.

The implementation of FIG. 1 is mainly suitable for use within a chip to provide a novel communication chip. The implementation of FIG. 4 is mainly suitable for optimization and upgrading of an existing communication chip for enhancing the performance of the communication system.

In FIG. 4, when TXD transitions from low to high, as a voltage difference between the ends of the delay capacitor C1 cannot change abruptly, the port on the right side of C1 is high, turning on Q1 and Q2, as designed. As a result of Q1 and Q2 being turned on, the right side of C1 is gradually discharged, eventually pulling the voltage on the right side of C1 down. Consequently, Q1 and Q2 are turned off, as designed. In FIG. 4, a fifth resistor R5, a sixth resistor R6, a seventh resistor R7 and an eighth resistor R8 are included to: 1) pull down the triodes to achieve a default OFF state; and 2) to form an RC circuit together with C1, which is capable of setting turn-on times for Q1 and Q2.

Embodiments of the present invention also provide a communication structure including the encoder module 2 and the adaptive matching module 1, as defined above. The communication structure is used in a system.

As shown in FIG. 5, the adaptive module 1 may be integrated into a chip during fabrication thereof. In this case, the communication structure 3 is incorporated in the resulting chip, and the encoder module 2 and the adaptive matching module 1 each form part of the chip. The chip may also contain other modules with necessary functions, depending on the need of a practical application in which the chip is intended for use. Further description in this regard is believed to be unnecessary and therefore omitted herein.

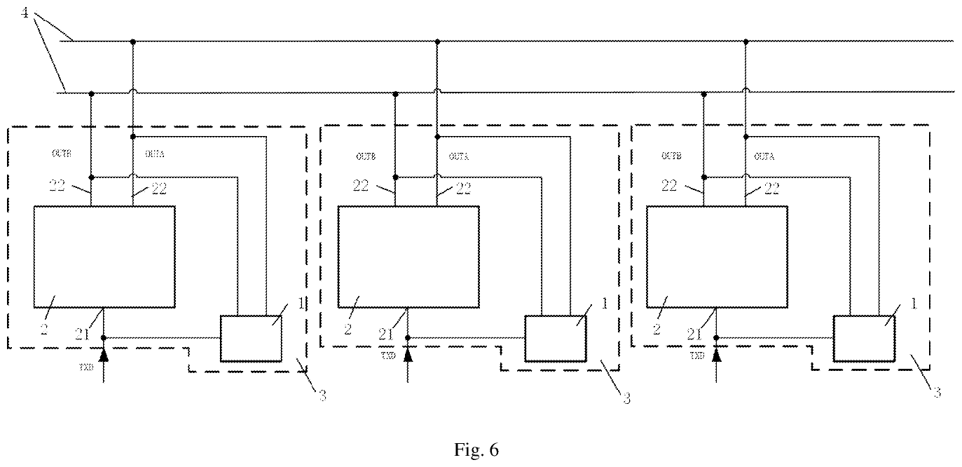

Alternatively, as shown in FIG. 6, the communication structure may be used with an existing communication chip. In this case, the communication structure may be constructed on the basis of the existing chip without much cost. In particular, the encoder module 2 may be incorporated in the chip, and the adaptive matching module 1 may be provided as a separate component mounted external to the chip.

As shown in FIG. 5, the communication structure 3 may be additionally provided with delay adjustment port (not shown), which can be connected to different resistances to cause corresponding changes in the current from the constant-current subunit, thus adjusting the aforementioned delay time.

In the embodiment of FIG. 6, the communication structure 3 can adjust the delay time by changing the capacitance of C1.

The embodiments of FIGS. 5 and 6 can provide distinct benefits in different operating conditions.

With continued reference to FIG. 6, embodiments of the present invention are advantageous over the prior art in multi-split applications, in which multiple devices with respective matching elements are mounted on a communication bus 4. When these devices are simultaneously connected to the communication bus 4, the matching elements will act in combination, possibly leading to DC resistance of the bus which is too low to allow a signal to be transmitted without being diminished by the resistors. This can be overcome by connecting a conventional encoder module 2 to the adaptive matching module 1 constructed with various elements, and multi-node communication can be advantageously achieved at a higher rate over a longer distance. One possible model of the encoder module 2 is XL1193. For air-conditioning systems, the adaptive matching module 1 is preferably added to each of chips of outdoor and indoor units.

The wiring shown in FIG. 6 is simplified, and those skilled in the art will recognize that, in order to provide necessary protective and shielding functions, capacitors, resistors and other components may be added to particular locations, and that a power supply and the like may also be added to appropriate locations. The addition of these components has nothing to do with the operating principles and benefits described herein and, therefore, need not be described in further detail herein.

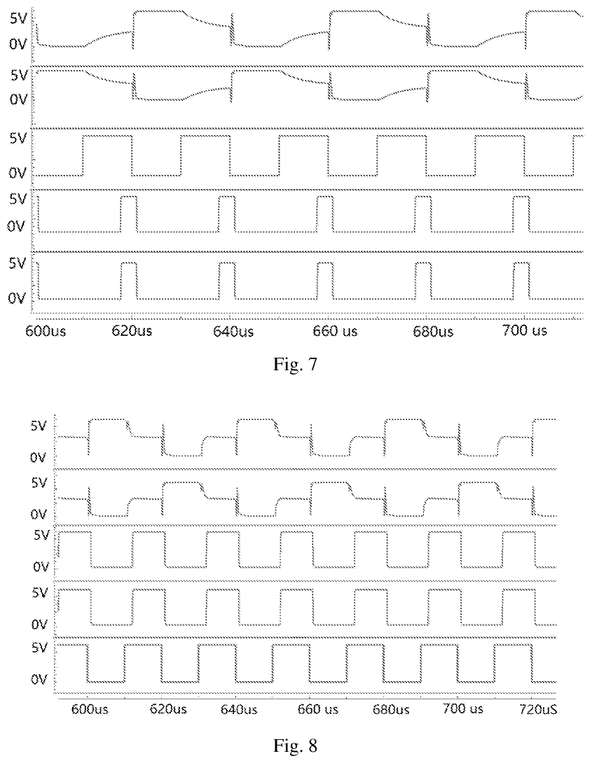

FIG. 7 shows simulated waveforms at a communication rate of 100 Kbps before an adaptive matching module 1 constructed in accordance with an embodiment of the present invention is employed. The waveforms are respectively OUTA, OUTB, TXD and DATAOUT in one device and DATAOUT received at another device, from the top downward. As can be seen, OUTA and OUTB transition slowly from the high or low level to the center level over a long period of time. Consequently, the decoded DATAOUT signal has a narrow high-level pulse width and suffers from serious distortion.

FIG. 8 shows simulated waveforms at a communication rate of 100 Kbps after an adaptive matching module 1 constructed in accordance with an embodiment of the present invention is employed. The waveforms are respectively OUTA, OUTB, TXD and DATAOUT in one device and DATAOUT received at another device, from the top downward. As can be seen, OUTA and OUTB rapidly transition from the high or low level to the center level, and the decoded DATAOUT signal has a desirable high-level pulse width, indicating successful transmission of the signal.

FIGS. 7 and 8 demonstrate that embodiments of the present invention indeed overcome the problem described in the Background section.

Aspects and benefits of the present invention are summarized as follows. In order to mitigate signal distortion caused by parasitic capacitance and impedance mismatching, a single matching resistor is typically connected in parallel to a bus. However, when communication is conducted among multiple terminal devices on the bus at a higher rate over a longer distance, only terminal devices close to the matching resistor can communicate with satisfactory quality, while the communication quality of distant terminal devices is poor. Theoretically, resistors can be parallel-connected around the respective terminals, but this will reduce resistance of the terminals on the bus. Consequently, a signal to be communicated over the bus may be difficult to drive, and its amplitude may be attenuated by the terminal resistance.

In order to overcome this problem, the concept of adaptive impedance matching is proposed herein, which involves connecting matching resistors in parallel to the respective terminal devices and keeping the matching resistors disconnected from the bus unless any signal needs to be sent. In this way, the matching resistors on the bus are allowed to have large capacitance. Moreover, in order to enable any of the terminal devices to send a signal, the respective matching resistor is connected to the bus. This can reduce the number of matching resistors on the bus and correct waveforms transmitted over the bus, ensuring that the devices on the bus receive correct signals.

This can be accomplished using a circuit, which is simple in structure, significantly effective and extremely low in power consumption. Moreover, it can modify its communication rate and allows for adaptive impedance matching. The matching resistors are connected only when so needed. Therefore, the impedance of the bus is not affected, and a large number of nodes are allowed to be mounted thereon. This concept can greatly improve the performance of a communication chip and enable a network with more participating devices to communicate at a higher rate over a longer distance.

Simulation results have shown that such a circuit can remarkably increase the communication rate and distance of an HBS chip and enable communication among a considerably larger number of nodes.

To conclude, embodiments of the present invention provide an adaptive matching module and a communication structure. The adaptive matching module includes a matching input, a state-switchable node, a delay unit, a switch unit and a waveform optimization unit. The matching input is configured to receive a signal from the encoder input. The state-switchable node switches its operating state according to the signal from the encoder input, and the delay unit restores the operating state of the state-switchable node after the elapse of a delay time. The switch unit connects the waveform optimization unit into the system only when there is a need to send a signal, and keeps it disconnected otherwise. When connected into the system, the waveform optimization unit reduces a transition period. With this arrangement, the waveform optimization unit reduces limitations of the transition period on the communication rate during the sending of a signal, and is disconnected when there is no need to send a signal. Thus, the waveform optimization unit does not affect electrical parameters of the entire system, overcoming the problem that it is conventionally impossible to further improve the communication rate, whether matching elements are added or not.

Described above are merely a few preferred embodiments of the present invention, which are not intended to limit the scope of the present invention in any way. Any and all changes and modifications made by those of ordinary skill in the art in light of the above teachings are intended to fall within the scope of the invention.

1. An adaptive matching module, being used with an encoder module and being used in a system, the encoder module comprising at least one encoder input and two encoder outputs, wherein in response to a transition of a signal at the encoder input from a first level to a second level, a voltage difference between the two encoder outputs transitions from a preset voltage-difference value to 0 V over a transition period, and a default value of the transition period has an impact on a communication frequency of the system,
the adaptive matching module comprising a matching input, a state-switchable node, a delay unit, a switch unit and a waveform optimization unit,
the matching input configured to receive the signal from the encoder input,
the state-switchable node switchable between at least a first operating state and a second operating state, wherein when the state-switchable node is in the first operating state, in response to a transition of the signal at the encoder input from the first level to the second level, the state-switchable node switches to the second operating state, and
in response to a transition of the signal at the encoder input from the first level to the second level, the delay unit switches the state-switchable node from the second operating state back to the first operating state after the elapse of a delay time,
when the state-switchable node is in the second operating state, the switch unit connecting the waveform optimization unit into the system, and when the state-switchable node is in the first operating state, the switch unit disconnecting the waveform optimization unit from the system,
wherein the waveform optimization unit, when connected into the system, reduces the transition period.

2. The adaptive matching module according to claim 1, wherein the waveform optimization unit is an impedance-matching resistor, when the impedance-matching resistor is connected into the system, the impedance-matching resistor is connected between the two encoder outputs.

3. The adaptive matching module according to claim 2, wherein the impedance-matching resistor comprises a first resistor and a second resistor, wherein the switch unit comprises a first triode and a second triode; bases of the first and second triodes are both connected to the state-switchable node; the first triode and the first resistor provide a path leading from a first one of the two encoder outputs to a second one thereof; the second triode and the second resistor provide a path leading from the second one of the two encoder outputs to the first one thereof; and when the first triode and the second triode are turned on, currents flow therethrough in opposite directions.

4. The adaptive matching module according to claim 1, wherein the delay unit comprises a delay capacitor, wherein in response to a transition of the signal at the encoder input from the first level to the second level, a charge-discharge state of the delay capacitor having a change, and after the elapse of the delay time, a voltage at one end of the delay capacitor reaches a value which triggers switching of the state-switchable node from the second operating state to the first operating state.

5. The adaptive matching module according to claim 4, wherein the delay unit comprises a constant-current subunit, wherein the delay capacitor is charged based on a current output from the constant-current subunit.

6. The adaptive matching module according to claim 5, wherein the delay unit further comprises a discharge subunit, wherein when the signal at the encoder input is at the first level, the discharge subunit operates to continually discharge the delay capacitor, and when the signal at the encoder input is at the second level, the discharge subunit is out of operation, and the delay capacitor receives charge from the constant-current subunit to gradually increase a voltage of the delay capacitor.

7. The adaptive matching module according to claim 4, wherein the delay capacitor is connected between the encoder input and the state-switchable node, wherein the end of the delay capacitor connected to the encoder input is configured as the matching input.

8. A communication structure, comprising an encoder module and the adaptive matching module of claim 1 and being used in a system, the encoder module comprising at least one encoder input and two encoder outputs, wherein in response to a transition of a signal at the encoder input from a first level to a second level, a voltage difference between the two encoder outputs transitions from a preset voltage-difference value to 0 V over a transition period, and a default value of the transition period has an impact on a communication frequency of the system.

9. The communication structure according to claim 8, wherein the communication structure is provided as a chip, and wherein the encoder module and the adaptive matching module each form part of the chip.

10. The communication structure according to claim 8, wherein the encoder module is a chip, and wherein the adaptive matching module is mounted external to the chip as a separate component.

11. The communication structure according to claim 9, wherein the delay unit comprises a delay capacitor, wherein in response to a transition of the signal at the encoder input from the first level to the second level, a charge-discharge state of the delay capacitor having a change, and after the elapse of a delay time, a voltage at one end of the delay capacitor reaches a value which triggers switching of the state-switchable node from the second operating state back to the first operating state; and
the delay unit comprises a constant-current subunit, and the delay capacitor is charged based on a current output from the constant-current subunit.

12. The communication structure according to claim 11, further comprising a delay adjustment port, when the delay adjustment port is connected to different resistors, the current from the constant-current subunit having corresponding changes, thereby changing the delay time.
